(19) United States
(12) Patent Application Publication
(10) Pub. No.: US 2025/0058361 A1
(43) Pub. Date: Feb. 20, 2025

(54) AUTOMATED SYSTEM FOR VERTICAL SORTING OF ARTICLES AND METHOD

(71) Applicant: FIVES XCELLA, LARMOR-PLAGE (FR)

(72) Inventor: Oussama CHERIF IDRISSI EL GANOUNI, PARIS (FR)

(21) Appl. No.: 18/721,495

(22) PCT Filed: Dec. 13, 2022
(86) PCT No.: PCT/EP2022/085512

§ 371 Date: Jun. 18, 2024

(30) Foreign Application Priority Data
Dec. 23, 2021 (FR) FR2114353

(51) Int. Cl. B07C 5/36; B65G 1/04

(52) U.S. Cl. CPC B07C 5/36; B65G 1/0492; B07C 2501/0063

(57) ABSTRACT

A system for vertical sorting of articles includes a rack extending in a longitudinal direction and having a plurality of sorting levels, each sorting level being configured to receive at least one sorting container; an automated sorting device configured to move an article from an article receiving level to a sorting level in order to deposit same into a sorting container; an automated discharge device configured to take a sorting container from a sorting level and move it to a discharge level.

### TECHNICAL FIELD OF THE INVENTION

The invention relates to the field of intralogistics in general and is in particular directed to an automated article sorting system, for example in a warehouse.

### STATE OF THE ART

In this field, systems for sorting parcels and other articles are of particular importance, especially with the increase in e-commerce.

Traditionally, sorting systems include a main conveyor line which receives articles to be sorted and distributes them to a number of secondary lines which receive articles from the main line and route them to their predetermined distribution stations. A typical example of such a system is a cross-belt type sorting machine which comprises a train of carriages which is displaced in a closed circuit along loading stations, which are designed to load the carriages with the articles to be sorted, and unloading stations, where the articles are unloaded and generally accumulated prior to delivery.

One problem with this type of sorting system is that they are of very large overall size due to the space occupied by the conveyors on the ground and the fact that the output stations can be spread around the outer periphery of the facility.

Another problem is that if maintenance is required on one component of the sorting machine, the entire line ceases to function, and the line can only resume operation after repairs have been carried out.

The purpose of the invention is therefore to provide an article sorting system with a reduced overall size on the ground while retaining good sorting capacity, with respect to known facilities, and allowing flexibility for maintenance.

### SUMMARY OF THE INVENTION

To this end, the invention relates to a vertical article sorting system comprising:
a racking extending along a longitudinal direction and having a plurality of sorting levels, each sorting level being configured to receive at least one sorting container,
an automated sorting device configured to displace an article from an article reception level to a sorting level to set it down into a sorting container,
an automated discharge device configured to take a sorting container from a sorting level and displace it to a discharge level.

By arranging the sorting system in multiple stages, the space occupied on the ground can be significantly reduced with respect to known sorting systems in the state of the art.

A sorting container is generally referred to as a “chute” by those skilled in the art. Furthermore, the sorting system provided here should be distinguished from a simple sequencing system, for example in an order preparation system.

Advantageously, the system can include a plurality of automated sorting devices. This makes it possible to increase sorting capacity on the one hand and on the other hand to increase flexibility of the system in the event of maintenance, in particular if they can operate independently of each other. Indeed, in the event of maintenance on one sorting device, at least one other sorting device remains available to continue the sorting operation.

Advantageously, the sorting system can further comprise a sorting aisle located on one side of the racking, said aisle being adjacent and parallel to the racking, the sorting device is configured to be displaced in said sorting aisle.

For the purposes of the invention, the sorting aisle represents the three-dimensional space in which an autonomous mobile robot can be displaced horizontally and vertically.

Advantageously, the discharge device is also configured to be displaced in the sorting aisle. This makes for a more compact system and increases storage capacity for sorted articles.

Advantageously, the sorting device can also be a discharge device. This simplifies drive of the system by reducing the number of devices to be driven.

According to one alternative, the system can further comprise a discharge aisle adjacent and parallel to the racking and arranged on the other side of the racking with respect to the sorting aisle, the discharge device being configured to be displaced in said discharge aisle. This has the advantage of avoiding heap in the sorting aisle by reserving it solely for sorting and therefore increasing the sorting rate.

Advantageously, the sorting device can be an Autonomous Mobile Robot (AMR) comprising climbing means able to cooperate with complementary climbing means arranged in the sorting aisle, and transfer means for transferring the article to the sorting container.

Advantageously, the sorting system can include a plurality of autonomous mobile robots as sorting means.

An AMR is used to transport one or more articles to be sorted from the reception level (e.g. the ground) and displace it to the sorting level. Such an AMR can be adapted to quickly transport an article to be sorted to make sorting efficient. By way of example, it may be small enough to transport an article (e.g. parcel) to be sorted, it may be light enough to be raised and lowered quickly, and so on.

Multiplying the number of AMRs makes vertical sorting more efficient.

According to embodiments, the discharge device can be an automatically guided carriage distinct from an autonomous mobile robot (AMR) and is adapted for transporting sorting containers, said carriage comprising climbing means able to cooperate with complementary second climbing means, arranged in the sorting aisle or the discharge aisle, and gripping means for gripping a sorting container to be displaced.

The discharge device can be specifically adapted to the transport of sorting containers. On the one hand, discharge requires a device that is large and robust enough to allow sorting containers to be loaded (in particular loaded with sorted articles), and on the other hand the discharge operation does not need to be carried out at the same speed as the sorting operation. Thus, it is possible to have a limited number of robust carriages, but with simplified mechanics just sufficient to transport a container, for example, from a sorting level to a discharge level.

Thus, by combining in the sorting system, a plurality of light and fast AMRs adapted to ensure the sorting operation by transporting the articles to be sorted from the reception level (the ground) to the sorting level, and on the other hand carriages adapted to ensure displacement of sorting containers (especially when they are full), an efficient sorting system with reduced costs is obtained.

According to embodiments:
a sorting level may comprise a sorting track allowing displacement of the autonomous mobile robot in said sorting level from or towards a sorting container,
the sorting aisle may comprise a sorting well connecting said sorting track to the article reception level, said sorting well comprising complementary climbing means to allow displacement of the autonomous mobile robot in the well.

According to embodiments:
a sorting level may comprise a discharge aisle allowing displacement of the automatically guided carriage in said sorting level to take or set down a sorting container to be displaced,
the discharge aisle may comprise a discharge well connecting said discharge track to the article discharge level, said discharge well comprising complementary second climbing means to allow displacement of the automatically guided carriage in the discharge well.

The invention also relates to an article sorting method implementing the sorting system as previously described.

### BRIEF DESCRIPTION OF THE FIGURES

Further features and advantages of the invention will become apparent from the description below in relation to the appended drawings, given by way of non-limiting examples, in which:

FIG. 1 represents a simplified example of a sorting system according to the invention, in a front view.

FIG. 2 represents a first alternative of the sorting system according to the invention, in a front view.

FIG. 3 represents a second alternative of the sorting system according to the invention, also in a front view.

FIG. 4 represents a top view of the sorting system of FIG. 3.

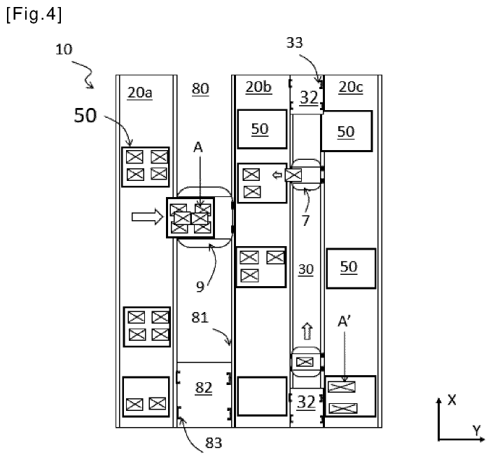

In the remainder of the description, elements having an identical structure or similar functions may be designated with the same references.

### DETAILED DESCRIPTION

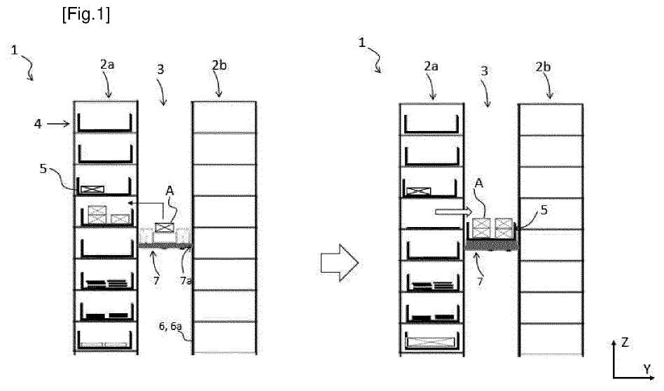

The invention relates to a vertical article sorting system. FIG. 1 schematically represents a front view of a first simplified example of a sorting system 1 according to the invention. The sorting system 1 comprises a three-dimensional racking 2a formed of a plurality of levels 4, also known as sorting levels. The racking 2a extends along the longitudinal direction X and comprises a sorting container 5 at each sorting level 4. A sorting level 4 may also have a plurality of sorting containers along the longitudinal direction.

To carry out sorting operations, the system 1 comprises an automated sorting device 7 configured to displace an article A from an article reception level, for example from the lowest level of the facility (ground level) and displace it to a sorting level 4 to set it down in a sorting container 5.

The sorting device can have different shapes, for example a shuttle, a robotic arm or an Autonomous Mobile Robot (AMR).

In the example of FIG. 1, the sorting device 7 is an AMR which comprises climbing means 7a, of a type known to the person skilled in the art, for example toothed wheels. The AMR 7 is configured to be displaced in the sorting aisle 3 adjacent to the racking 2a. To enable vertical displacement of the AMR, the aisle 3 may include climbing means, such as posts 6 fitted with racks 6a. The AMR can rotate its toothed wheels, which cooperate with the racks to allow it to displace up or down.

The system of FIG. 1 may moreover comprise a second racking 2b parallel to racking 2a.

The sorting system 1 also comprises an automated discharge device configured to take a (for example full) sorting container 5 from a sorting level and displace it to a discharge level, or vice versa.

The discharge device can take different forms, for example a shuttle, a manipulator or even an AMR 7 such as that used as a sorting device. According to preferred embodiments, the discharge device can be an automatically guided carriage 9 adapted to the displacement of the sorting containers 5 (see FIG. 1, right).

In this case, the AMRs 7 are reserved for sorting individual articles and can be reduced in size and displaced at high speeds to increase the sorting rate. For discharge, on the other hand, large carriages are required, which can be kept small number and displaced at low speeds to preserve integrity of the container being displaced. This also reduces costs while increasing sorting performance.

In the example of FIG. 1, the full containers can be discharged from the same sorting aisle 3.

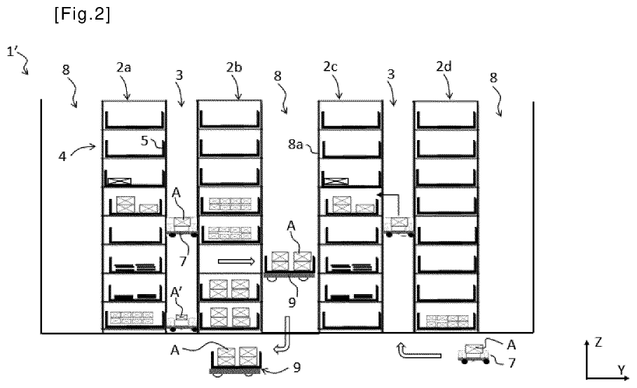

However, according to preferred examples, as represented by FIG. 2, a discharge aisle 8 parallel and opposite to the sorting aisle 3 can be added. In this case, the automatically guided carriage 9 is configured to displace the sorting containers into the discharge aisle 8.

In the example of FIG. 2, the sorting system comprises 4 rackings 2a to 2d. In other examples not illustrated, it may comprise a greater number of rackings.

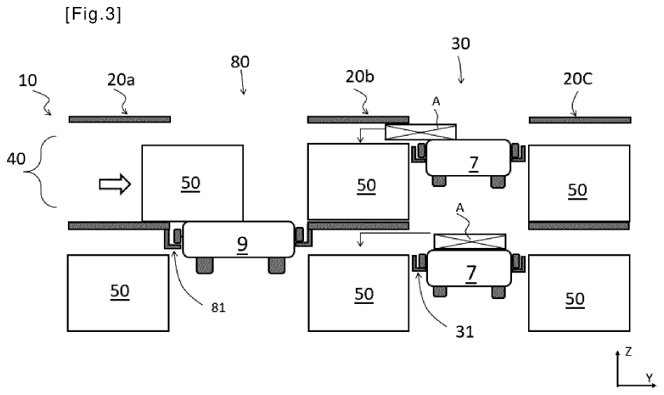

FIG. 3 shows one exemplary embodiment wherein the sorting system 10 comprises:
a sorting level 40 which comprises a track 31 allowing displacement of the autonomous mobile robot in said sorting level 40 from or towards the sorting container 50. In the example, track 31 is arranged in aisle 30. Advantageously, several sorting levels 40 can each comprise a track to allow displacement within the sorting level.
the sorting aisle 30 comprises a well 32 connecting the track(s) 31 to the article reception level (e.g. the ground or the roof).
   The track may comprise rails, for example.
   Well 32 comprises climbing means 33 to allow displacement of the autonomous mobile robot 7.

Advantageously, aisle 3 may comprise a plurality of wells 32, for example a first well 32 may be reserved for the ascent of the AMRs and a second well 32 reserved for their descent. The robots can thus ascend from one well and descend from another to increase performance.

Advantageously, the track height can be adapted to the height of the sorting container to facilitate transfer of article A.

The robot may comprise means for transferring articles to the sorting container, for example a mobile cross-belt.

Advantageously, the transfer means can be adapted to the height of the container. For example, the robot may have a telescopic platform carrying the mobile belt on which the article is placed.

The system of FIG. 3 may further comprise a discharge aisle 80. The discharge aisle may comprise a discharge track 81 and a second well 82 connecting said track to the article discharge level.

The second well comprises complementary climbing means 83 to allow displacement of the automatically guided carriage.

The climbing means arranged in the sorting aisle and/or in the discharge aisle may comprise posts fitted with racks. They may also comprise any other climbing means known to the person skilled in the art.

The invention is also directed to an article sorting facility which comprises an article sorting system as previously described. In such a facility the system may, for example, be arranged so that the lowest level is the ground. Alternatively, it may be buried so that the ground is the highest level and may therefore correspond to the article reception level and/or discharge level.

The invention also relates to an article sorting method implementing the sorting system described above.

1. A system for vertically sorting articles comprising:
a racking extending along a longitudinal direction and having a plurality of sorting levels, each sorting level being configured to receive at least one sorting container,
an automated sorting device configured to displace an article from an article reception level to a sorting level in order to set it down in a sorting container,
an automated discharge device configured to take a sorting container from a sorting level and displace it to a discharge level.

2. The sorting system according to claim 1, further comprising a sorting aisle located on one side of the racking, said aisle being adjacent and parallel to the racking, the sorting device is configured to be displaced in said sorting aisle.

3. The sorting system according to claim 2, wherein the discharge device is also configured to be displaced in the sorting aisle.

4. The sorting system according to claim 3, wherein the sorting device is also a discharge device.

5. The sorting system according to claim 2, further comprising a discharge aisle adjacent and parallel to the racking and arranged on the other side of the racking from the sorting aisle, the discharge device being configured to be displaced in said discharge aisle.

6. The sorting system according to claim 2, wherein the sorting device is an Autonomous Mobile Robot comprising climbing means able to cooperate with complementary climbing means arranged in the sorting aisle, and transfer means for transferring the article to the sorting container.

7. The sorting system according to claim 5, wherein the discharge device is an automatically guided carriage distinct from an autonomous mobile robot and is adapted to transport sorting containers, said carriage comprising climbing means able to cooperate with complementary second climbing means, arranged in the discharge aisle, and gripping means to take a sorting container to be displaced.

8. The sorting system according to claim 6 wherein:
a sorting level comprises a sorting track allowing displacement of the autonomous mobile robot in said sorting level from or to a sorting container,
the sorting aisle comprises a sorting well connecting said sorting track to the article reception level, said sorting well comprising complementary climbing means to allow displacement of the autonomous mobile robot in the well.

9. The sorting system according to claim 8, wherein:
a sorting level comprises a discharge track allowing displacement of the automatically guided carriage in said sorting level to take or set down a sorting container to be displaced,
the discharge aisle comprises a discharge well connecting said discharge track to the article discharge level, said discharge well comprising complementary second climbing means to allow displacement of the automatically guided carriage in the discharge well.

10. A method for sorting articles implementing the sorting system according to claim 1.
